(19) United States
(12) Patent Application Publication
(10) Pub. No.: US 2018/0348618 A1
(43) Pub. Date: Dec. 6, 2018

(54) CLASSROOM PRESENTATION GUIDANCE SYSTEM

(71) Applicant: Benjamin Tylisz, West Lafayette, IN (US)

(72) Inventor: Benjamin Tylisz, West Lafayette, IN (US)

(21) Appl. No.: 15/927,761

(22) Filed: Mar. 21, 2018

Related U.S. Application Data
(60) Provisional application No. 62/514,954, filed on Jun. 5, 2017.

(51) Int. Cl. G03B 21/26; G09B 5/02; G03B 21/132

(52) U.S. Cl. CPC G03B 21/26; H04N 9/3185; G03B 21/132; G09B 5/02

(57) ABSTRACT

A presentation system includes an overhead projector having a stage supporting a display article, an upwardly extending arm, a projector head supported by the arm above the stage. The projector head is configured to transmit an image of the display article to a remote display surface. A light source emits an indicator marker on the stage for registering the display article on the stage, such that the image of the display article is properly located and oriented on the remote display surface.

### CROSS-REFERENCE TO RELATED APPLICATION

The present application claims priority to U.S. Provisional Patent Application Ser. No. 62/514,954, filed Jun. 5, 2017, the disclosure of which is expressly incorporated herein by reference.

### BACKGROUND AND SUMMARY OF THE DISCLOSURE

The present invention relates generally to a presentation system and, more particularly, to a presentation guidance system including an overhead projector and a display article registration device.

In classrooms, presentation systems often include an overhead projector configured to display an article, such as a piece of paper, on a remote display surface or screen. With such presentation systems, instructors often have a difficult time realizing which portion of the display article is being projected on the screen. As such, students may have to request the instructor to move the display article, often causing the instructor turn around and view the screen, usually from an odd angle, and waste presentation time. By projecting a registration marker or outline associated with what is being displayed by the projector, the instructor may observe the relative position of the display article as projected on the display screen at all times without having to actually view the display screen.

According to an illustrative embodiment of the present disclosure, an overhead projector includes a stage for supporting a display article, an upwardly extending arm, and a projector head supported by the arm above the stage. The projector head is configured to transmit an image of the display article to a remote display surface. A light source emits an indicator marker on the stage for registering the display article on the stage.

According to a further illustrative embodiment of the present disclosure, a registration device for an overhead projector includes a projector head having a receiver configured to receive an image of the display article and a transmitter configured to transmit the image of the display article to a remote display surface. A light source emits an indication marker downwardly for registering the article relative to the receiver to facilitate proper location and orientation of the image of the display article on the remote display surface.

According to another illustrative embodiment of the present disclosure, a method of registering a display article on an overhead projector includes the steps of emitting an indicator marker downwardly from a light source supported by a projector head, the indicator marker defining a registration perimeter on a stage, registering a display article relative to the registration perimeter on the stage, and projecting an image of the display article on a remote display surface.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF DRAWINGS

A detailed description of the drawings particularly refers to the accompanying figures, in which:

FIG. 1 is a side elevational view of an illustrative presentation system of the present disclosure;

FIG. 2 is a side elevational view of a further illustrative embodiment presentation system of the present disclosure;

FIG. 3 is a bottom view of an illustrative projector head of the presentation system of FIG. 2;

FIG. 4 is a block diagram of the illustrative presentation system of FIG. 2;

FIG. 5A is a top plan view of a stage with a registration perimeter and display article in a first position relative to the registration perimeter;

FIG. 5B is a front plan view of a display screen associated with the display article of FIG. 5A;

FIG. 6A is a top plan view of a stage with a registration perimeter and display article in a second position relative to the registration perimeter; and

FIG. 6B is a front plan view of a display screen associated with the display article of FIG. 6A.

### DETAILED DESCRIPTION OF THE DRAWINGS

For the purposes of promoting and understanding of the principles of the present disclosure, reference will now be made to the embodiments illustrated in the drawings, which are described herein. The embodiments disclosed herein are not intended to be exhaustive or to limit the invention to the precise forms disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods in further applications of the principles of the invention which normally occur to one skilled in the art to which the invention relates.

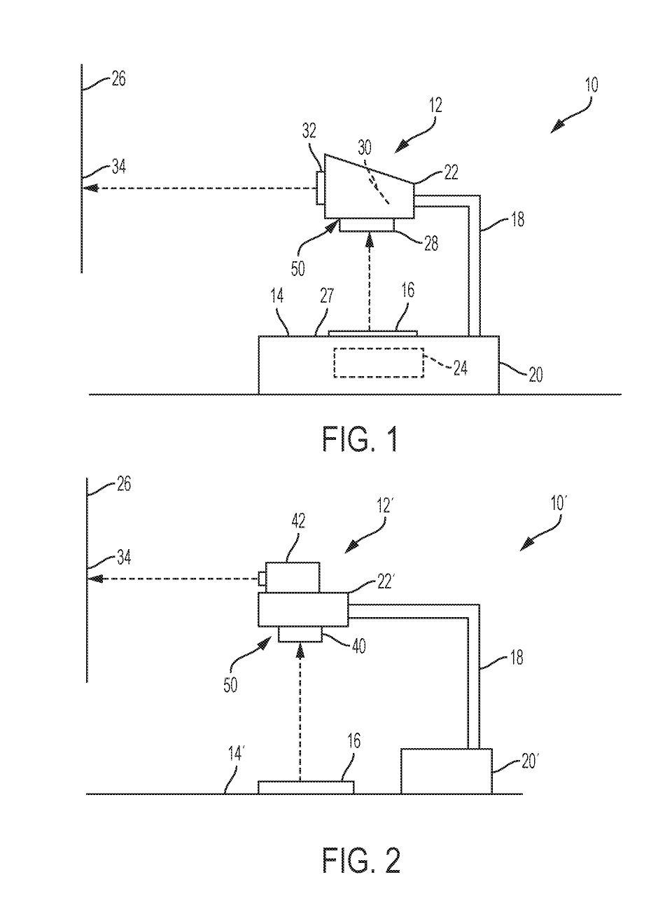

Referring initially to FIGS. 1 and 2, an illustrative presentation, or display, system 10, 10′ includes an overhead projector 12, 12′. The overhead projector 12, 12′ includes a stage 14, 14′ for supporting a display article 16. An arm 18 extends upwardly from a base 20, 20′ and supports a projector head 22, 22′ above the stage 14, 14′. The projector head 22, 22′ is configured to transmit an image 34 of the display article 16 to a remote display surface 26.

With further reference to FIG. 1, according to illustrative embodiment overhead projector 10, a light emitter 24 is positioned below the stage 14. The light emitter 24 may comprise a conventional projector lamp. Light from the light emitter 24 is configured to transmit through an upper transparent support surface 27 and the display article 16, illustratively a transparent sheet, upwardly to the projector head 22. The projector head 22 illustratively includes a first lens 28 to receive light and direct it to a reflector 30. The reflector 30 reflects the light to a second lens 32 which directs an image 34 of the display article 16 to the remote display surface 26, which may comprise a reflective display screen.

With further reference to FIGS. 2 and 4, according to another illustrative embodiment of the present disclosure, the projector head 22′ illustratively includes a digital image receiver or camera 40 configured to capture an electronic image 34 of the display article 16. A projector 42 is illustratively in electrical communication with the camera 40 via a controller 46. More particularly, the image 34 from the camera 40 is provided to the controller 46 which then transmits the image 34 to the projector 42. A power supply 48 is illustratively in electrical communication with the controller 46, and hence the camera 40 and the projector 42. The projector 42 is configured to transmit the display article image 34 to the remote display surface 26. In certain illustrative embodiments, the projector head 22′ may be of the type in Model No. TT-02rx, available from Elmo of Plainview, N.Y., USA.

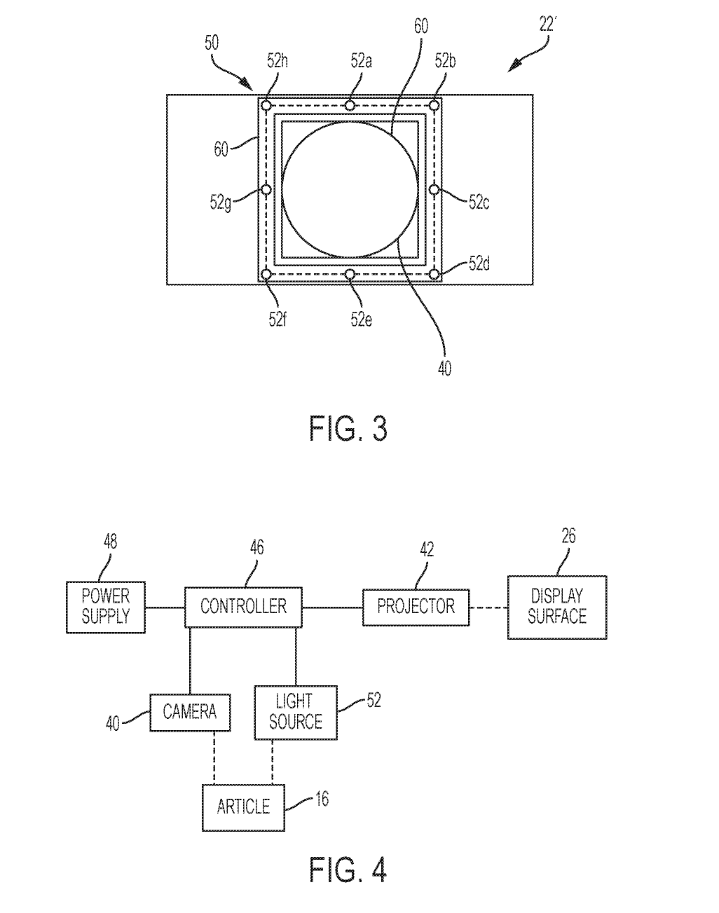

With reference to the illustrative embodiment of FIGS. 2 and 3, a registration device 50 is supported by a lower surface of the projector head 22′. The registration device 50 illustratively includes a plurality of light sources 52a-52h supported by the projector head 22 and configured to assist the user in locating and orienting (i.e., registering) the display article 16 on the stage 14. More particularly, the light sources 52a-52h are configured to emit light downwardly to generate a plurality of indicator markers 54a-54h on the stage 14 to assist the user in registering the display article 16 on the stage 14.

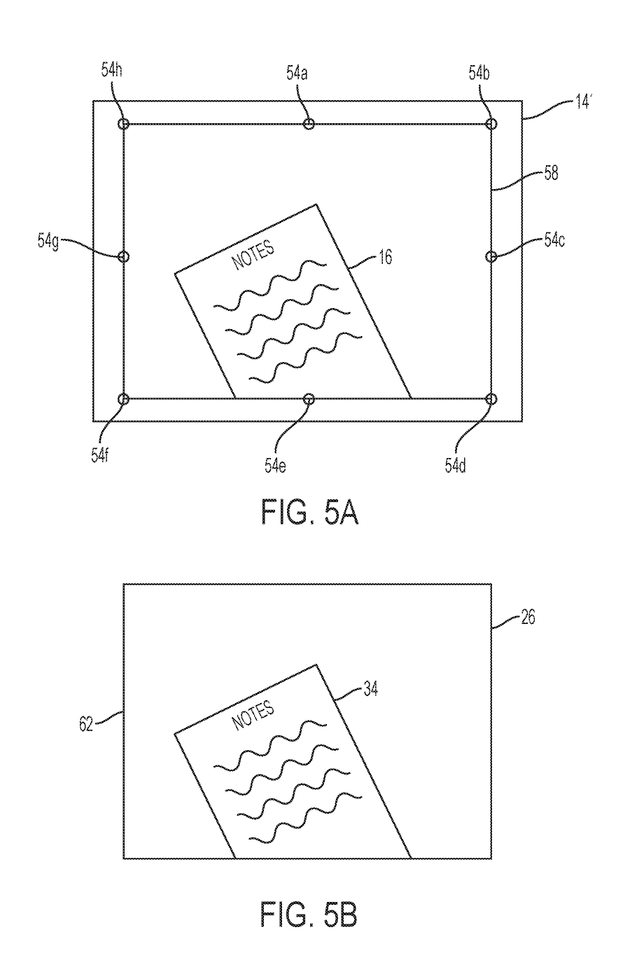

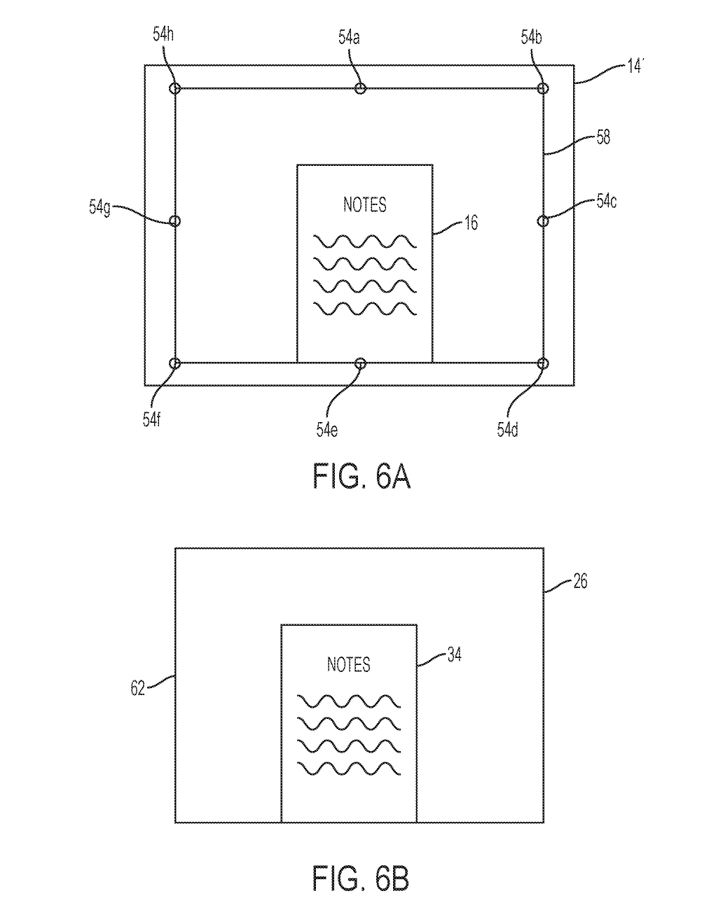

With further reference to FIG. 3, the light sources 52 illustratively comprise a plurality of light emitting diodes (LEDs) configured to project light downwardly from the projector head 22 toward the stage 14. As shown in FIGS. 5A and 6A, the light emitting diodes 52 illustratively produce the plurality of indication markers 54 defining a registration outline or perimeter 58. While in the illustrative embodiment, eight separate light sources 52a-52h and associated indication markers 54a-54h are illustrated, it should be appreciated that the number and respective locations of the light sources 52 and the indication markers 54 may vary.

In certain illustrative embodiments, a lens 60 may be positioned proximate the light emitting diodes 52, and is configured to diffuse the light emitted from the plurality of light emitting diodes 52. As such, the light emitting diodes 52 may define a substantially continuous rectangular registration perimeter 58 on the stage 14′. As shown in FIGS. 5B and 6B, the remote display surface 26 may define an outline 62 associated with the rectangular registration perimeter 58.

In operation, the light sources 52 of the registration device 50 emit the plurality of indicator markers 54 downwardly from the projector head 22′. The indicator markers 54 illustratively define a registration perimeter 58 on the stage 14′. The display article 16 may be registered relative to the registration perimeter 58 on the stage 14′ by the user. The image 34 of the display article 16 is in projected on the remote display surface 26. More particularly, the display article 16 may be positioned and oriented relative to the registration perimeter 58 by the user, such that the associated display article image 34 is properly positioned and oriented on the display screen 26 for the viewers in the classroom.

FIG. 5A is a top plan view of the stage 14, 14′ with the display article 16 in a first position relative to the registration perimeter 58. FIG. 5B is a front plan view of the display screen 26 associated with the display article 16 in the relative position and orientation of FIG. 5A.

FIG. 6A is a top plan view of a stage 14, 14′ with the display article 16 in a second position relative to the registration perimeter 58. FIG. 6B is a front plan view of a display screen 26 associated with the display article 16 in the relative position and orientation of FIG. 6A.

Although the invention has been described in detail with reference to certain preferred embodiments, variations and modifications exist within the spirt and scope of the invention as described and defined in the following claims.

1. An overhead projector comprising:
a stage for supporting a display article;
an upwardly extending arm;
a projector head supported by the arm above the stage, the projector head configured to transmit an image of the display article to a remote display surface; and
a light source for emitting an indicator marker on the stage for registering the display article on the stage.

2. The overhead projector of claim 1, further comprising:
a light emitter below the stage; and
wherein the projector head includes a reflector, and the display article includes a transparent sheet, light from the light emitter configured to pass through the transparent sheet and to be reflected by the reflector to the remote display surface.

3. The overhead projector of claim 1, wherein the projector head includes a camera configured to capture an image of the display article, and a projector configured to transmit the image to a remote display surface.

4. The overhead projector of claim 1, wherein the light source comprises a plurality of light emitting diodes configured to project light downwardly toward the stage and define a plurality of indicator markers defining a registration perimeter.

5. The overhead projector of claim 4, further comprising a lens positioned proximate the plurality of light emitting diodes, and configured to diffuse light from the plurality of light emitting diodes to define the registration perimeter as substantially continuous.

6. The overhead projector of claim 4, wherein the registration perimeter is rectangular.

7. The overhead projector of claim 6, wherein the remote display surface defines an outline associated with the rectangular registration perimeter.

8. A registration device for an overhead projector, the registration device comprising:
a projector head including a receiver configured to receive an image of a display article, and a transmitter configured to transmit the image of the display article to a remote display surface; and
a light source for emitting an indication marker downwardly for registering the article relative to the receiver to facilitate proper location and orientation of the image of the display article on the remote display surface.

9. The registration device of claim 8, wherein the receiver and the transmitter are defined by a reflector.

10. The registration device of claim 8, wherein the receiver is defined by a camera, and the transmitter is defined by a projector.

11. The registration device of claim 8, wherein the light source comprises a plurality of light emitting diodes configured to project light downwardly and define a plurality of indicator markers defining a registration perimeter.

12. The registration device of claim 11, further comprising a lens positioned proximate the plurality of light emitting diodes, and configured to diffuse light from the plurality of light emitting diodes to define the registration perimeter as substantially continuous.

13. The registration device of claim 11, wherein the registration perimeter is rectangular.

14. The registration device of claim 13, wherein the remote display surface defines an outline associated with the rectangular frame of the registration perimeter.

15. A method of registering a display article on an overhead projector, the method comprising the steps of:
emitting an indicator marker downwardly from a light source supported by a projector head, the indicator marker defining a registration perimeter on a stage;
registering a display article relative to the registration perimeter on the stage; and
projecting an image of the display article on a remote display surface.

16. The method of claim 15, wherein the light source comprises a plurality of light emitting diodes configured to project light downwardly toward the stage and define a plurality of indicator markers defining the registration perimeter.

17. The method of claim 16, further comprising a lens positioned proximate the plurality of light emitting diodes, and configured to diffuse light from the plurality of light emitting diodes and define the registration perimeter as substantially continuous.

18. The method of claim 16, wherein the registration perimeter is rectangular.

19. The method of claim 18, wherein the remote display surface defines an outline associated with the rectangular frame of the registration perimeter.
